(19) United States
(12) Patent Application Publication
(10) Pub. No.: US 2012/0005929 A1
(43) Pub. Date: Jan. 12, 2012

(54) ADVERTISING MEDIUM AND ADVERTISING MEDIUM SYSTEM

(76) Inventor: Christina Kawka, Bietigheim (DE)

(21) Appl. No.: 12/814,093

(22) Filed: Jun. 11, 2010

(30) Foreign Application Priority Data
Dec. 12, 2007 (EP) PCT/EP2008/010390

(51) Int. Cl. G09F 23/06; G09F 7/00

(52) U.S. Cl. 40/637; 40/584

(57) ABSTRACT

The invention relates to an advertising medium (01) embodied as a cocktail umbrella having at least one surface (02) that is imprinted, or can be imprinted with an advertising imprint (11), which is intended as decoration of a beverage or of a food and has a locking position, wherein the advertising medium (01) requires a minimum of space and has an open position (10) in which an advertising imprint (11) applied to the imprintable or imprinted surface (02) is completely visible and the advertising medium (01) has the advertising effect thereof. The invention further relates to an advertising medium system, comprising at least such imprintable or imprinted advertising medium, and to a display for receiving the at least one advertising medium.

### CROSS-REFERENCE TO RELATED APPLICATION

This application claims the benefit of the priority filing date in PCT/EP2008/010390 referenced in WIPO Publication WO/2009/074277. The earliest priority date claimed is Dec. 12, 2007.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

1. Field of the Invention

The invention relates to an advertising medium as generically defined by the preamble to claim 1, and to an advertising medium system as generically defined by the preamble to claim 3.

2. Background of the Invention

Particularly in the gastronomic field, it is possible, with a suitable advertising medium, to distribute advertising that covers a wide area in a simple and economical way.

Known is German Utility Model DE 94 14 027 U1, an advertising medium of simple structure, for instance, in the form of a beverage coaster or beer coaster, or in the form of a cardboard plate or in the form of a bracelet or headband.

Known is German Utility Model DE 298 12 685 U1, an advertising medium in the form of a beverage coaster or beer coaster. By symmetrically distributing or arranging information fields and advertising fields, the effectiveness of the advertising medium is improved at no significant additional expense.

Known is German Utility Model DE 80 11 690 U1, an advertising medium in the form of a clamp-on medallion that can be placed on disposable flatware.

Known is German Utility Model DE 93 11 989 U1, an advertising medium that has a sufficiently large and easily imprinted surface, and this advertising medium can be a container for a gift.

Known is German Utility Model DE 1 774 964 U1, an advertising medium system, including an imprintable or imprinted advertising medium as well as a display for containing the at least one advertising medium. The advertising medium system includes a ship's hull as the display, the hull being provided with a mast, and napkins which can be or are disposed on the mast and which have a surface as the advertising medium that can be or is imprinted with an advertising imprint. The hull of the ship can be provided with an advertising imprint as well.

Known is German Utility Model DE 296 08 783 U1, an advertising medium system, including a beverage coaster or beer coaster, which simultaneously serves as packaging for an advertising medium embodied as a chip card or magnet card the size of a credit card, such as a telephone card, customer card, or cash card.

The disadvantages of the known advertising media are as follows:
An extremely small storage volume, limited by the size of the imprintable or imprinted surface, and a shape of only limited compactness for shipping and storage.
An intended use as an everyday article for absorbing liquids and for wiping up food and drink residues; as a result, the advertising media become unattractive, and even in the unused state, they have more of a repulsive effect.
Use as an accompaniment to the packaging of the actual item of interest; as a result, after the item of interest is removed, the advertising medium is thrown away and is paid no further attention.
A limited advertising effect because the advertising imprint is seen only by a person who directly uses the advertising medium, and only for a short time before the everyday article is used.

The known advertising medium systems furthermore have only a moderate decorative effect, which is due in part to the disadvantages of the advertising media used.

Furthermore, the known advertising media and advertising medium systems are not suitable for use in the field of gastronomy, for instance, in bars with an especially elegant ambiance that offer a wide selection of drinks.

### Technical Object of the Invention

It is therefore the object of the invention to develop an improved advertising medium and an improved advertising medium system that do no have the disadvantages of the prior art.

### Disclosure of the Invention and Its Advantages

The object is attained by an advertising medium having the characteristics of claim 1 and by an advertising medium system having the characteristics of claim 3.

A first subject of the invention accordingly relates to an advertising medium having at least one surface imprintable or imprinted with an advertising imprint, which advertising medium is intended for decorating a beverage or food and has a closed position, in which the advertising medium requires minimal storage space, and an open position, in which an advertising imprint applied to the imprintable or imprinted surface is entirely recognizable and in which the advertising medium visibly develops its advertising effect for all to see.

The advertising medium of the invention is especially well suited for use in the gastronomic field, especially in bars with an especially elegant ambiance that offer a wide selection of beverages such as cocktails, long drinks, and mixed drinks.

Compared to the prior art, the advertising medium has a substantially improved advertising effect, since it is not intended to be used for absorbing liquids and wiping up food and drink residues, and as a result it does not become unattractive or repulsive. Using the advertising medium to decorate a beverage or food means that for the length of time needed to consume the beverage or food, the advertising medium is perceived as not only pleasant but also as an enhancement to the appearance of the food or drink, which amplifies the advertising effect, and because of this, the advertising medium does not lose its significance as quickly as in the prior art. Moreover, the advertising imprint is seen not only by a person consuming a drink, but also by others, such as persons standing or seated at a bar. Furthermore, it is not seen merely for a short period of time. Because of its closed position and open position, the advertising medium also has a mass in the lengthwise direction of the imprintable or imprinted surface that is smaller than the maximum dimensions of the imprintable or imprinted surface. The result is an especially compact storage volume and shape, making shipping and storage especially easy.

An especially advantageous feature of the advertising medium of the invention provides that the advertising medium is embodied as a cocktail umbrella, and the top of the cocktail umbrella includes the imprintable or imprinted surface.

A second subject of the invention relates to an advertising medium system, including at least one imprintable or imprinted advertising medium and a display for containing the at least one advertising medium. The advertising medium is an advertising medium of the invention as described above. As a result, the advertising medium system allows the advantages over the prior art that result from the advertising medium of the invention to be utilized.

An advantageous feature of the advertising medium system of the invention provides that the display is a spherical portion, into which the at least one advertising medium is insertable or inserted in its closed position or open position, so that the at least one advertising medium already develops its advertising effect in the state in which it is still stored in the display.

The display preferably comprises a foam material that can be poked into or pierced by means of a pointed object, such as a pin, toothpick, or the like.

The foam material is preferably a foamed thermoplastic.

Especially preferably, the thermoplastic is a polystyrene.

Advantages of the advertising medium system of the invention over the prior art are obtained in particular because the advertising medium system, as a result of the advertising medium, in particular the cocktail umbrella, inserted into the display in the form of part of a sphere, for instance a hemispherical display, has an especially highly decorative effect, comparable to that of a bouquet of flowers, for instance.

Exemplary embodiments of the invention are shown in the drawings and will be described in further detail hereinafter.

### DRAWINGS

FIG. 1 is a schematic view of an advertising medium of the invention, embodied as a cocktail umbrella, in an open position, in perspective;

FIG. 2 is a schematic view of an advertising medium of the invention, embodied as a cocktail umbrella, in a closed position, in perspective;

FIG. 3 shows an advertising medium system, with advertising media of the invention embodied as cocktail umbrellas, in perspective.

### LIST OF REFERENCE NUMERALS

01 Advertising medium; cocktail umbrella
02 Surface
03 Frame
04 Canopy
05 Shank
06 Ring
07 Ribs
08 Spreaders
09 Top; crown
10 Open position
11 Advertising imprint
12 Closed position
13 Advertising medium system
14 Display; spherical portion

### DETAILED DESCRIPTION OF THE DRAWINGS

### Ways of Embodying the Invention

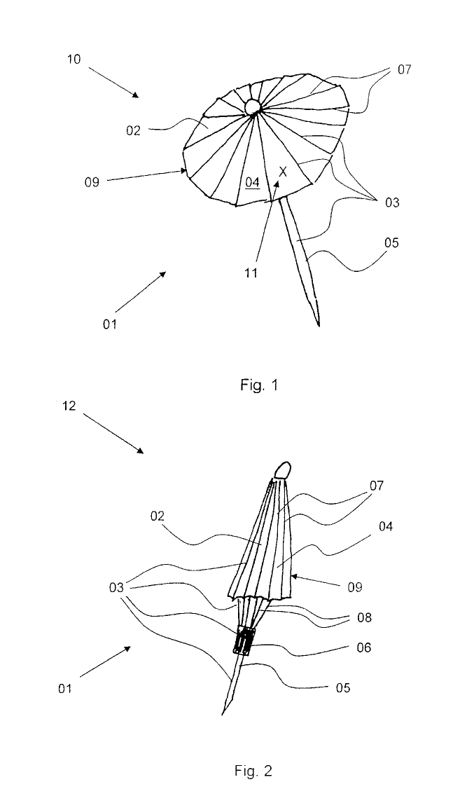

An advertising medium 01, shown in FIGS. 1 and 2, which is intended for decorating a beverage or food, is embodied as a cocktail umbrella 01 and has a surface 02 that is imprintable or imprinted with an advertising imprint 11. The cocktail umbrella 01 essentially comprises a frame 03 and a canopy 04. The frame 03 includes a shank 05, a ring 06 that is displaceable along the shank 05, ribs 07 that are provided with the canopy and are disposed pivotably on the end of the shank 05 that support the canopy 04, and spreaders 08, each connected in articulated fashion to the ring 05 and the ribs 07. The ribs 07 provided with the canopy 04 form the top 09, also called a crown 09, of the cocktail umbrella 01. The top 09 of the cocktail umbrella 01 includes the imprintable or imprinted surface 02.

The advertising medium 01 in FIG. 1 has an open position 10, in which an advertising imprint 11 applied to the imprintable or imprinted surface 02 is entirely recognizable, and in which the advertising medium 01 visibly develops its advertising effect for all to see.

The advertising medium 01 in FIG. 2 has a closed position 12, in which the advertising medium 01 requires minimal storage space.

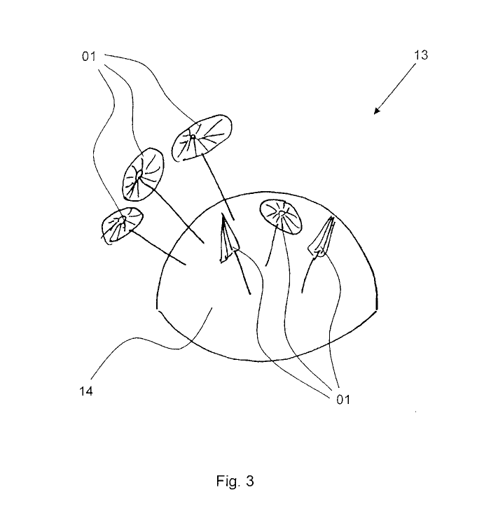

An advertising medium system 13 shown in FIG. 3 includes a plurality of imprintable or imprinted advertising media 01 as well as a display 14 for containing the advertising media. The display 14 is a spherical portion 14, into which the advertising media 01, embodied as cocktail umbrellas 01, are insertable or inserted in the closed position 12 or open position 10, so that the advertising media 01 already develop their advertising effect in the state in which they are stored in the display. The display 14 preferably comprises a foam material of a foamed thermoplastic, preferably polystyrene, that can be poked into or pierced by a pointed object, such as a pin, toothpick, or the like.

### INDUSTRIAL APPLICABILITY

The invention is industrially applicable particularly in the field of the production and use of advertising media.

What is claimed:

1. An advertising medium (01), having at least one surface (02) imprintable or imprinted with an advertising imprint (11), characterized in that the advertising medium (01) is intended for decorating a beverage or food and has a closed position (12), in which the advertising medium (01) requires minimal storage space, and an open position (10), in which an advertising imprint (11) applied to the imprintable or imprinted surface (02) is entirely recognizable and in which the advertising medium (01) develops its advertising effect.

2. The advertising medium of claim 1, characterized in that the advertising medium (01) is embodied as a cocktail umbrella (01), and the top (09) of the cocktail umbrella (01) includes the imprintable or imprinted surface (02).

3. An advertising medium system (13), including at least one imprintable or imprinted advertising medium (01) and a display (14) for containing the at least one advertising medium (01), wherein the advertising medium (01)
has at least one surface (02) imprintable or imprinted with an advertising imprint (11), characterized in that the advertising medium (01) is intended for decorating a beverage or food and has a closed position (12), in which the advertising medium (01) requires minimal storage space, and an open position (10), in which an advertising imprint (11) applied to the imprintable or imprinted surface (02) is entirely recognizable and in which the advertising medium (01) develops its advertising effect, or
is a cocktail umbrella (01), and the top (09) of the cocktail umbrella (01) includes the imprintable or imprinted surface

4. The advertising medium system as defined by claim 3, characterized in that the display (14) is a spherical portion (14), into which the at least one advertising medium (01) is insertable or inserted in its closed position (12) or open position (10), so that the at least one advertising medium (01) already develops its advertising effect in the state in which it is still stored in the display (14).

5. The advertising medium system as defined by claim 4, characterized in that the display (14) comprises a foam material.

6. The advertising medium system as defined by claim 5, characterized in that the foam material is a foamed thermoplastic.

7. The advertising medium system as defined by claim 6, characterized in that the thermoplastic is a polystyrene.
